(19) United States
(12) Patent Application Publication
(10) Pub. No.: US 2018/0311105 A1
(43) Pub. Date: Nov. 1, 2018

(54) NOVELTY TOY

(71) Applicant: PARK END DESIGN LTD, Grove, Oxon Oxfordshire (GB)

(72) Inventor: Paul LONERGAN, Grove, Oxon Oxfordshire (GB)

(21) Appl. No.: 15/578,510

(22) PCT Filed: Jun. 1, 2016
(86) PCT No.: PCT/GB2016/051610

§ 371 Date: Nov. 30, 2017

(30) Foreign Application Priority Data
Jun. 1, 2015 (GB) 1509445.1

(51) Int. Cl. A61H 19/00

(52) U.S. Cl. CPC A61H 19/44; A63H 3/04

(57) ABSTRACT

A toy comprising a stack of elements including at least first, second and third elements having a cord running therethrough. The cord is configurable between a taut state in which the stack is prevented from toppling, and a slack state in which the first, second and third elements are movable relative to one another to effect toppling of the stack. The first element comprises a stop configured to limit movement of the second element relative to the first element to a pre-determined range such that the stack is only partially toppled by movement of the second element through the pre-determined range, and movement of the first and/or third element is necessary for the stack to reach a fully-toppled state.

### FIELD OF THE INVENTION

The invention relates to toys, in particular to toys known in the art as ‘pop toys’ or ‘push puppets’, or other toys containing cord-based mechanisms.

### BACKGROUND TO THE INVENTION

‘Pop toys’ (also known as ‘push-button puppets’ or Wakouwas) are toys that are traditionally directed at young children. Pop toys comprise a stack of elements including a base element having a sprung push-button on the under surface, and toy elements that are usually configured in the shape of an animal or character. A cord in the form of a string is anchored between the push-button and the uppermost element of the stack initially, the cord is pulled taut by the action of the spring against the button. The tautness of the cord retains the elements in an upright position against the action of gravity, even if the toy is tilted. When a user pushes the button and overcomes the biasing force of the spring, the cord is slackened. In its slackened state, the cord can no longer prevent toppling of the stack under gravity, and if the toy is held at even a small tilt, the stack of elements will topple over. When the button is released the cord is tautened once more, pulling the elements into an upright stack once again.

Such pop toys were first made by the Swiss toy maker Walter Kourt Walss in the 1930's. The mechanism described above was patented in U.S. Pat. No. 2,421,179, published in 1947. Pop toys have been a popular child's toy ever since and are still common today. They have remained substantially unchanged since their inception and still using the mechanism described above and in U.S. Pat. No. 2,421,179.

Although pop toys remain popular, there are some limitations on the collapsing effect that can be achieved using the cord and push-button mechanism described.

It is intended that pop toys should topple in a cascade-like fashion, with each element tumbling over as the stack topples. However, in practice, this effect can be difficult or even impossible to achieve. The elements of the stack often have a tendency to fall in a hinge-like motion from the bottom toy element, with the other toy elements remaining stacked one-on top-of-another as the stack falls. The result is that the stack falls from its base like a felled tree, which is less amusing than the desired toppling effect. This ‘felled-tree’ effect is particularly prevalent if the toy elements have a relatively large area of contact, for example if the toy elements have large, flat upper surfaces, or if the toy elements are of substantially the same size and shape. This tends to limit pop toys to constructions having small and uneven elements, which limits the shape and size of pop toys.

In order to allow enough room for the cord to slacken and to enable the elements to topple freely, a certain amount of clearance must be provided between the elements and the cord. This permits rotation of the elements relative to one another, and also allows the elements to move out of alignment with one another so that the elements are not stacked precisely one-on-top-of-another. In this way, some of the elements of the stack are usually off-balance. When the cord is slackened by pressing the button, the toppling action is governed solely by gravity. The pattern of toppling therefore depends on the degree to which any elements in the stack are misaligned and hence off-balance, and the angle at which the toy is tilted when the button is pushed. The toppling motion therefore occurs differently each time, and cannot be predicted or controlled. This means that the mechanism cannot be used to create a specific toppling motion.

The ability of the elements to rotate and move relative to one another around the cord also means that the elements do not always return to the same upright configuration. When the elements topple, some elements typically rotate as they fall under the action of gravity, such that when the button is released they return to the stack in a rotated position. This is often seen, for example, in toys shaped as animals, where the head of the animal may face forwards initially, but return to the stack facing in a different direction. Thus, the upright configuration of the toy is not consistent.

Pop toys are traditionally hand-made toys. To make a pop toy, a knot is tied at one end of a cord and a button is threaded onto the cord via an aperture in the button until the button comes into contact with the knot. The knot prevents the button becoming unthreaded. Other components are then threaded onto the cord in order: first the spring, then the base element, and finally the toy elements. The cord is knotted above the last toy element to prevent the elements unthreading, and the toy is then complete. The process is time-consuming and requires considerable man-power, resulting in a low efficiency and hence a low rate of manufacture.

Against this background, it is an object of the invention to address at least one of the problems associated with the known pop toys described above.

### STATEMENTS OF THE INVENTION

From a first aspect, the invention resides in a toy composing a stack of elements including at least first, second and third elements having a cord running therethrough. The cord is configurable between a taut state in which the stack is prevented from toppling, and a slack state in which the first, second and third elements are movable relative to one another to effect toppling of the stack. The first element comprises a stop configured to limit movement of the second element relative to the first element to a pre-determined range such that the stack is only partially toppled by movement of the second element through the pre-determined range, and movement of the first and/or third element is necessary for the stack to reach a fully-toppled state.

By virtue of the stop, full toppling of the stack cannot be effected by movement of the second element alone. Other elements of the stack must also move relative to one another in order to achieve a fully-toppled state of the stack. Thus, the stop forces elements of the stack other than the second element to move relative to one another during toppling. The toy must therefore topple with a controlled splaying movement, and the ‘felled tree’ effect described above is thereby avoided. This toy of the invention therefore provides a more appealing and entertaining toppling motion compared to conventional pop toys described above.

Furthermore, by virtue of the stop, a similar controlled splaying effect can be repeated reliably every time the toy is used, so that the shape of the toppled stack can be controlled. The ability to control the shape of the toppled stack means that configurations can be reliably achieved by the toy of the invention that could not be achieved by conventional pop-toys.

It will be appreciated that the terms ‘first’, ‘second’ and ‘third’ are arbitrarily assigned labels, and any elements of a stack of elements could be considered to be ‘first’, ‘second’ and ‘third’ elements. For example, the ‘first’, ‘second’ and ‘third’ elements need not be stacked in order. Additional elements of the stack may also be provided.

The second element may define an internal volume, and the stop of the first element may be located inside the internal volume of the second element. Locating the stop inside the internal volume of the second element disguises the stop such that it is not visible in use, and so does not interfere with the shape defined by the toy.

The first element may comprise a support surface and the second element may rest on the support surface when the first and second elements are arranged in the stack. In this case, the stop may be spaced apart from the support surface by a spacer. In this case, the spacing between the stop and the support surface determines the range of movement of the second element, which determines the configuration adopted by the second element in the toppled state. The spacing can therefore be selected to correspond to a desired range of movement of the second element, and hence a desired shape of the toy in the toppled state.

For compactness, the cord may run through the spacer. The spacer may be a post, for example of circular cross-section.

The second element may have a base wall comprising an aperture and the spacer may extend through the aperture into the internal volume of the second element. In this case, the aperture may have at least one dimension that is smaller than a dimension of the stop so as to guard against the stop passing through the aperture to limit movement of the second element relative to the first element. In this way, the surface surrounding the aperture acts as an abutment surface that abuts against the stop.

At least one dimension of the aperture may be larger than a dimension of the post. This provides a clearance between the post and the walls surrounding the aperture that facilitates pivoting of the second element relative to the first element in all permitted directions.

The stop may be provided on a stop formation. For ease of manufacture, the stop formation may comprise the stop and the spacer, such that the stop and the spacer are integral with one another.

The stop formation may comprise an abutment surface that faces towards the support surface of the first element, in which case the abutment surface may act as the stop.

The stop formation may comprise a sloped surface opposite the abutment surface, which may be, for example, a domed surface. The sloped surface acts as a ramp that, when the toy is being assembled, facilitates the process of forcing the stop formation of the first element through the aperture of the second element.

The elements may be configured such that the second element can be tilted in any direction with respect to the first element to permit toppling of the stack in any direction. Alternatively, the elements may be configured to tilt in a particular direction relative to one another. In embodiments having a spacer in the form of a post, this may be achieved by shaping the post and the aperture through which the post extends to allow pivoting in restricted directions only, for example by providing a non-circular post and aperture.

The second element may comprise an abutment surface for abutting against the stop to restrict movement of the second element relative to the first element. The abutment surface may be an internal wall of the second element. In this way, the abutment surface may be shielded from view when the toy is in use.

The first and second elements may comprise complementary locating features configured to align the second element relative to the first element when the first and second elements are arranged in the stack. By virtue of these locating features, when the elements spring back from the fully-toppled state into the stacked state, the elements are automatically aligned as required. The toy therefore returns reliably to the correct alignment each time the toy springs back to the upright state.

The locating feature of the first element may be provided on the support surface of the first element. For compactness of design, the locating feature may comprise a projection on the support surface.

The projection may comprise at least one sloping wall that lies at an obtuse angle to the support surface. In use, the sloping wall may act as a ramp that facilitates location of the second element relative to the first element.

For compactness of design, the projection may define a bevel that extends at least partially around the base of the spacer. For example, the bevel may define a collar around the projection.

The locating feature of the second element may be provided on a base surface of the second element. For example, the locating feature of the second element may comprise a recess on the base surface.

The locating feature may comprise at least one sloping wall that lies at an obtuse angle to the base surface. In use, the sloping wall may act as a ramp that facilitates location of the second element relative to the first element.

In embodiments in which the second element includes both a locating formation in the form of a recess and an aperture, the recess may be defined by a bevelled wall that surrounds the aperture of the second element.

The second element may comprise a stop configured to limit movement of the third element relative to the second element to a pre-determined range. Alternatively or additionally, the second element may comprise a stop configured to limit movement of the first element relative to the second element to a pre-determined range. The toy may comprise additional elements, in which case those additional elements may also be provided with stops for limiting movement of neighbouring elements in the stack.

The second and third elements may comprise complementary locating features configured to align the third element relative to the second element when the elements are arranged in the stack.

One of the elements may be a base element that houses a button configured to slacken the cord when the button is pressed.

In this case, the base element and button may be shaped so as to prevent rotation of the button within the base element. For example, the base element and button may each have a non-circular shape to prevent rotation of the button housed in the base element.

The cord may be a cord that is flexible but that has a stiffness along a longitudinal axis of the cord. For example, the cord may be made of a plastics material, in particular a thermoplastic such as nylon. The flexibility of the cord allows the cord to bend to accommodate toppling of the stack, while the stiffness of the cord means that the cord resists twisting, and that the cord can be used to push one or more of the elements of the stack to encourage toppling.

From another aspect, the invention resides in a toy comprising a stack of elements, a movable base and a cord running through the stack of elements and being anchored between the base and an anchoring element of the stack such that movement of the base slackens the cord to allow the stack to topple. The cord composes a snap-fit feature that is engaged with the anchoring element to anchor the cord thereto.

The snap-fit feature provides a secure and simple means of engaging the anchoring element with the cord. The anchoring element cannot be easily disengaged from the cord during use, making the toy particularly durable, yet the anchoring element can be quickly and easily engaged with the snap-fit feature during assembly of the toy, without the need for complex parts or intricate knots, making the manufacturing process simpler, more efficient, and more readily capable of automation.

For a particularly simple snap-fit arrangement, the anchoring element may comprise an aperture and the snap-fit feature of the cord may extend through the aperture.

The snap-fit feature may comprise first and second parts and the first and second parts may be disposed on different sides of the aperture.

The first part may compose a first stop, and the anchoring element may comprise an aperture having at least one dimension that is smaller than the first stop, so as to prevent the first stop passing through the aperture.

The second part may comprise a second stop and the aperture of the anchoring element may have at least one dimension that is smaller than the second stop.

For ease of assembly of the toy, the second stop may be elastically deformable to reduce at least one dimension of the second stop so as to allow the second stop to pass through the aperture of the anchoring element when the second stop is deformed.

In this case, the second part may be configured such that the second stop can be elastically deformed by threading the aperture of the anchoring element over the second part in a threading direction to allow the second stop to pass through the aperture of the anchoring element in the threading direction.

The second part may be configured such that the second stop resists elastic deformation when the aperture of the anchoring element is pushed over the second past in an unthreading direction opposite the threading direction, so as to prevent the second stop passing through the aperture in the unthreading direction.

In this way, the anchoring element could pass over the second part in the threading direction by elastically deforming the second stop, whereupon it abuts against the stop of the first part and can move no further in the threading direction. The anchoring element cannot be moved over the second part in the unthreading direction, because deformation of the second stop is prevented on moving the anchoring element in the unthreading direction. The anchoring element is thereby trapped between the stops of the first and second parts in the assembled toy.

To facilitate threading the anchoring element over the stop during assembly of the toy, the second part may comprise a ramped surface opposite the second stop.

For ease of assembling the toy, at least one other element in the stack may comprise an aperture that is larger than the first stop, so as to allow the first stop to pass through the aperture of the or each other element during assembly of the toy.

The first part of the snap-fit feature may be a lower part that is closest to the movable base, and the second part of the snap-fit feature may be an upper part that is furthest from the movable base.

The snap-fit feature and the aperture may be shaped to prevent rotation of the snap-fit feature in the aperture. Shaping the snap-fit feature and the aperture in this way means that the anchoring element is prevented from rotating with respect to the cord, such that the anchoring element cannot rotate out of place relative to the cord as the stack is toppled and then brought back to an upright state, thereby ensuring the desired orientation of the anchoring element relative to the cord when in the upright state.

The cord may comprise a further snap-fit feature that is engaged with the movable base to anchor the cord thereto. The further snap-fit feature provides a quick and easy means of engaging the cord with the base during assembly of the toy.

The base may comprise an aperture and the snap-fit feature of the cord may extend through the aperture. In this case, the snap-fit feature and the aperture may be shaped to prevent rotation of the snap-fit feature in the aperture. Shaping the snap-fit feature and the aperture in this way means that the cord cannot rotate out of place relative to the base as the stack is toppled and then brought back to an upright state, thereby ensuring the desired orientation of the cord relative to the base when in the upright state.

The base may be housed in a base element of the stack, and the base and base element may be configured to prevent rotation of the base relative to the base element. Configuring the base and base element in this way means that the base cannot rotate relative to the base element.

A particular advantage may be gained when the base is prevented from moving relative to the base element, the cord is prevented from rotating relative to the base, and the anchoring element is prevented from rotating relative to the cord. This arrangement prevents the base element and anchoring element rotating relative to one another, such that they remain in the same relative orientation throughout use of the toy. This is further assisted when the cord has a stiffness along a longitudinal axis of the cord, as this prevents twisting of the cord. Avoiding relative rotation of the elements is particularly beneficial when the base element and the anchoring element define parts of an object or character that should remain at a fixed relative orientation for best effect. For example, if the base element defines the feet of a character and the anchoring element defines the head of a character, the feet and head would remain facing the same way throughout use of the toy.

At least a part of the snap-fit feature may be disposed outside the anchoring element.

The cord may have a stiffness along a longitudinal axis of the cord. For example, the cord may be made from a plastics material such as nylon. For ease of manufacture, the cord may be an injection-moulded cord.

The or each snap-fit feature may be integral with the cord. In this way, the cord and the or each snap-fit feature can be provided as a single component without the need to attach the snap-fit features to the cord, resulting in a particularly simple and efficient manufacturing process.

The invention also extends to a method of making a toy comprising a stack of elements, a movable base and a cord running through the stack of elements and being anchored between the base and an anchoring element of the stack. The method comprises: providing a cord having a base anchored thereto and a snap-fit feature; threading elements of the stack onto the cord, and snap-fitting the anchoring element of the stack into engagement with an engagement feature of the cord, thereby anchoring the cord between the base and the anchoring element.

The step of snap-fitting the anchoring element into engagement with the engagement feature may comprise threading the anchoring element onto the engagement feature. Snap-fitting the anchoring element into engagement with the engagement feature by means of a simple threading action allows a fast and simple method of assembling the toy, which increases efficiency of the manufacturing process.

The engagement, feature may comprise first and second parts, and the method may comprise forcing the anchoring element over the second part into engagement with the engagement feature.

The second part may compose a stop, the anchoring element may comprise an aperture having at least one dimension that is smaller than the stop, and the method may comprise elastically deforming the stop to allow the anchoring element to pass over the stop of the second part. Elastically deforming the stop avoids the need for complex parts or mechanisms that might otherwise be required to engage the cord with the anchoring element.

The step of threading elements of the stack onto the cord may comprise threading at least one other element of the stack onto the cord such that the other element passes over the engagement feature without snap-fitting into engagement. Other elements of the stack may thereby be threaded onto the cord in the same way, further simplifying the manufacturing process.

The step of providing a cord having a base anchored thereto may comprise anchoring the base to the cord. In this way, the movable base and the cord can be provided as separate components that are easy to manufacture, for example by injection moulding, and the components can be engaged together. In this case, for a particularly simple manufacturing method, the method may comprise snap-fitting the case into engagement with a further engagement feature provided on the cord.

The method may comprise threading the elements onto the cord by moving the elements relative to the cord. Alternatively, threading the elements onto the cord may be effected by moving the cord relative to the elements.

For ease of manufacture of the toy, the method may comprise trimming the cord above the engagement feature after the anchoring element has been snap-fitted into engagement with the engagement feature.

The invention also extends to a toy made by the method above.

Any of the toys described above may be shaped substantially as a body part. For example, the toy may be shaped substantially as genitalia.

It will be appreciated that preferred and/or optional features of one aspect of the invention may be used alone, or in appropriate combination, with other aspects of the invention also.

### BRIEF DESCRIPTION OF THE DRAWINGS

Embodiments of the invention will now be described, by way of example only, with reference to the accompanying drawings, in which:

FIG. 1 is a front view of a toy in an upright state;

FIG. 2 is a front view of the toy of FIG. 1 in a fully-toppled state;

FIG. 3 is a cross-sectional view of the toy of FIG. 1 in an upright state;

FIG. 4 is a cross-sectional view of the toy of FIG. 1 in a fully-toppled state;

FIG. 5a is a cross-sectional view of a base element forming a part of the toy of FIG. 1;

FIG. 5b is a cross-sectional view of an intermediate element forming a part of the toy of FIG. 1;

FIG. 5c is a cross-sectional view of an anchoring element forming a part of the toy of FIG. 1;

FIG. 5d is a cross-sectional view of a base element and an intermediate element forming a part of the toy of FIG. 1;

FIG. 6a is a cross-sectional view of the toy of FIG. 1 in a partially-toppled state;

FIG. 6b is a cross-sectional view of the toy of FIG. 1 in another partially-toppled state;

FIG. 6c is a cross-sectional view of the toy of FIG. 1 in a fully-toppled state;

FIG. 7a is a front view of a cord forming part of the toy of FIG. 1, and

FIGS. 7b and 7c are partial enlarged views of snap-fit elements of the cord of FIG. 7a; and

FIGS. 8a to 8e illustrate steps in a method of making the toy of FIG. 1.

### DETAILED DESCRIPTION OF EMBODIMENTS OF THE INVENTION

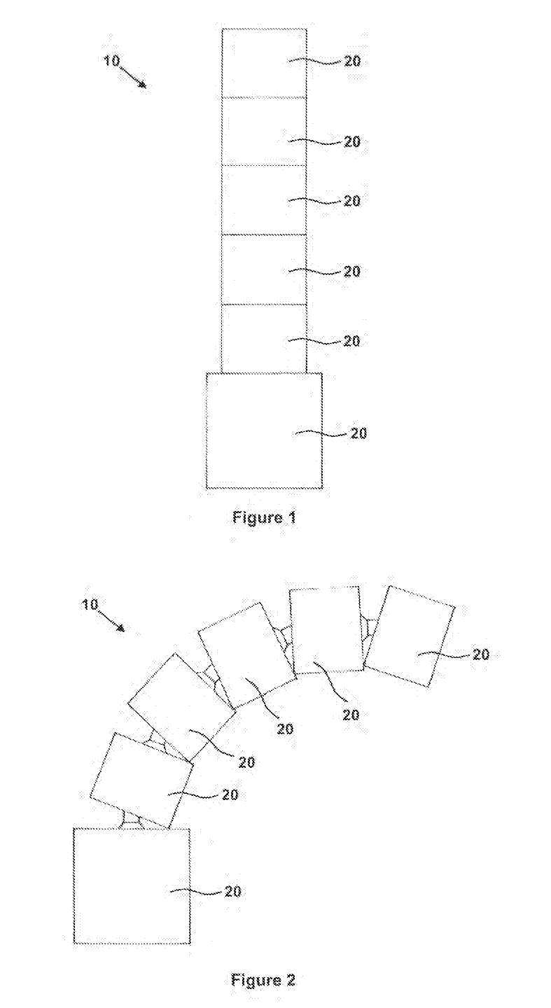

FIGS. 1 and 2 illustrate a toy 10 that comprises a plurality of stacked elements 20. In the embodiment shown, each element 20 is a cylindrical element of circular cross section, though the elements 20 may be shaped in any suitable manner, for example to create the appearance of an object or character. In particular, the toy may have an adult-theme, and the elements may be shaped as a body part, and in particular as genitalia.

The toy 10 is configurable between a first, upright state, illustrated in FIG. 1, in which the elements 20 are arranged one-on-top-of-another to define a stack, and a second, fully-toppled state, illustrated in FIG. 2, in which the elements 20 have toppled over. In the fully-toppled state, the elements 20 have moved with respect to one another to the maximum extent permitted by the internal mechanism or the toy 10. In other words, in the fully-toppled state, the elements 20 have toppled such that the total gravitational potential energy of the elements 20 is at the lowest level permitted.

Although in this case the elements are toppled by gravity acting on the stack, it will be appreciated that toppling may be caused by any force that tends to move the elements towards a toppled state. For example, the toppling may additionally or alternatively be caused by external elastic forces or pushing forces acting on the elements.

It will be appreciated that the toy 10 may be held and used in any orientation, such that the stack need not necessarily be upright in the first state. For example, if the toy 10 were held at 90 degrees to the orientation illustrated, the stack would be substantially horizontal with the elements 20 arranged side-by-side to define the stack. The term ‘stack’ therefore encompasses such possible non-upright orientations, so long as the elements are capable of toppling to some extent with respect to the first state.

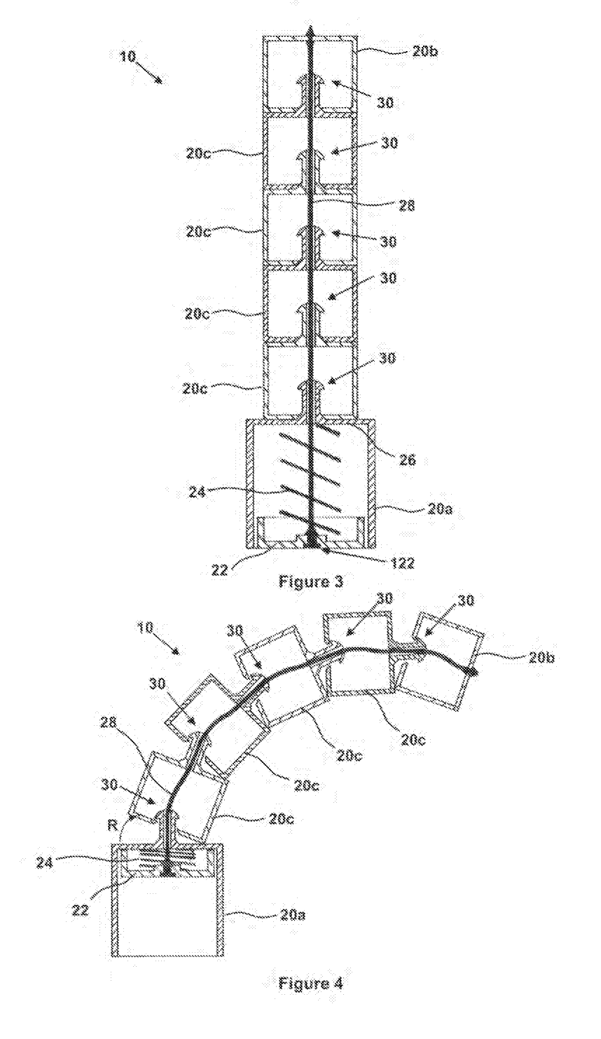

Referring to FIG. 3, which shows the toy 10 in cross section, the stack comprises three different types of elements 20a, 20b, 20c. A lowermost element of the stack is a base element 20a that houses a moveable base or button 22. An uppermost element of the stack serves as an anchoring element 20b. A cord 28 runs through all the elements and is anchored to the button 22 at the base of the stack and to the anchoring element 20b at the top of the stack. The remaining elements that are located between the base element 20a and the anchoring element 20b are intermediate elements 20c.

The button 22 is arranged to define a base surface of the base element 20a. The button 22 comprises an aperture 122 that engages with the cord 28. A spring 24 acts between the button 22 and an internal surface 26 of the base element 20a to bias the button 22 away from the internal surface 26. The cord 28 is pulled taut by the action of the spring 24, and the tautness of the cord 28 retains the elements 20a, 20b, 20c in their upright position.

In this example, the cord 28 is made of a plastics material such as nylon and is an injection-moulded cord. Because the cord 28 is made of a plastics material, the cord 28 is flexible but has a stiffness along the length of the cord 28, such that the cord 28 displays a resilience to bending. However, the cord 28 may be made of any other suitable material and need not have a stiffness along the length of the cord 28. For example, the cord 28 may be made of a fibrous string as is used in traditional pop toys, or may be made of metal.

Referring to FIG. 4, when a user pushes the button 22 up and into the base element 20a and overcomes the biasing force of the spring 24, the cord 28 becomes slack. The slackness in the cord 28 allows the elements 20a, 20b, 20c to move with respect to one another so that the stack topples. Once all the elements 20a, 20b, 20c have moved to the maximum extent permitted, the stack is in a fully-toppled state.

With the exception of the anchoring element 20b, each of the elements of the stack 20a, 20c, comprises a stop 30. Each stop 30 is configured to limit movement of a neighbouring element 20b, 20c of the stack to a limited range as the neighbouring element 20b, 20c topples. For example, the stop 30 of the base element 20a is configured to limit movement of the intermediate element 20c immediately above the base element 20a to a range of movement indicated by the arrow R.

By limiting relative movement of the elements 20a, 20b, 20c in this way, the relative movement of a single element 20a, 20b, 20c is not sufficient to bring the stack into its fully-toppled state. Instead, relative movement of a single element 20a, 20b, 20c brings the stack into only a partially-toppled state, in which the total gravitational potential energy of the elements 20a, 20b, 20c is not yet at the minimum level permitted by the toy 10. To bring the stack into its fully-toppled state, each of the other elements 20a, 20b, 20c must also move through their limited range of movement.

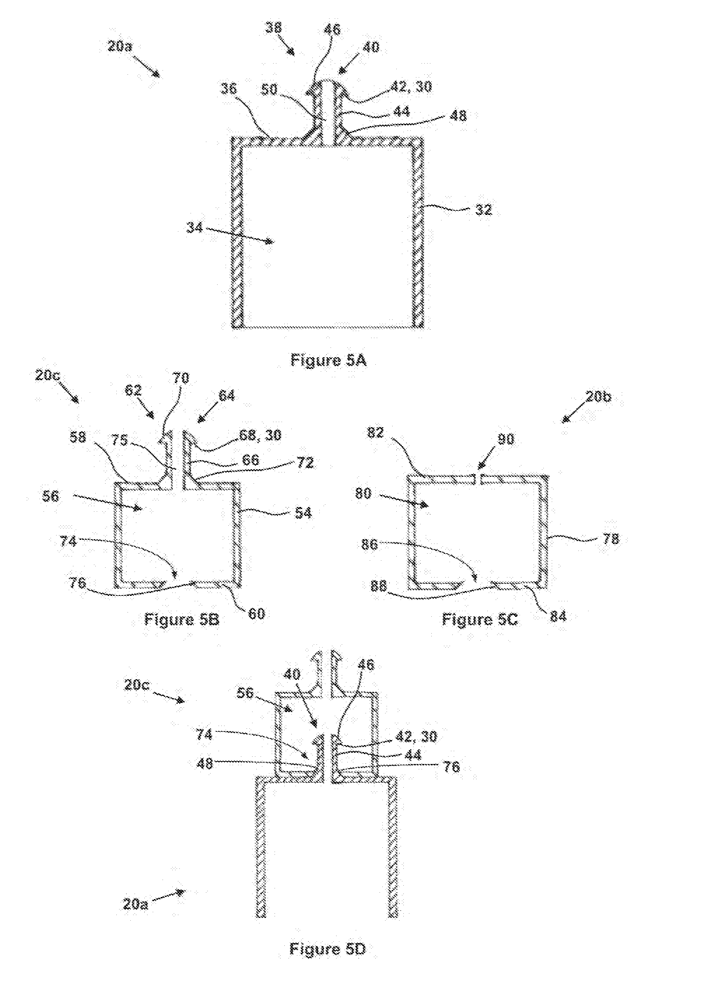

FIGS. 5A to 5C illustrate the different elements 20a, 20b, 20c of the stack, which will now be described in detail.

FIG. 5A is a cross-sectional view of the base element 20a of the stack. The base element 20a comprises a hollow housing 32 made of an injection-moulded plastics material. The housing 32 defines an internal volume 34 that, in use, houses the button 22 and the spring 24 (not shown in FIG. 5). The housing 32 defines an upper surface 36. When the toy is in the upright state, the neighbouring element 20c in the stack rests on the upper surface 36. By ‘rests’ it is meant that the neighbouring element 20c bears against the upper surface 36 in some way when the toy is in the upright state. This may be caused, for example, by the tautness of the cord pulling the neighbouring element 20c against the upper surface 36. Alternatively or additionally, if the stack is held upright, the neighbouring element 20c may also bear against the upper surface 36 by virtue of gravity pulling the neighbouring element 20c down against the upper surface 36. In this way, the upper surface 36 acts as a support surface.

The upper surface 36 of the base element 20a is provided with a stop formation 38. The stop formation 38 comprises a head portion 40 and a spacer 44 in the form of a post. The head portion 40 defines a mushroom shape, and has an abutment surface 42 that faces downwardly towards the upper surface 36 of the base element 20a to define the stop 30, and a domed surface 46 opposite the abutment surface 42. The spacer 44 serves to space the head portion 40, and hence the stop 30, away from the upper surface 36 of the base element 20a.

Where the upper surface 36 of the base element 20a meets the post 44, the upper surface 36 is provided with a bevelled region having a sloped surface that lies at an obtuse angle to the upper surface 36. The bevelled region extends all the way round the base of the post to define a collar 48. This collar 48 acts as a locating feature that interacts with a complementary locating feature on the neighbouring intermediate element 20c of the stack, as will be described later.

A central bore 50 runs through the stop formation 38 to communicate with the internal volume 34 of the base element 20a. In the assembled toy 10, the cord 28 runs through this central bore 50 into the internal volume 34, where it is anchored to the button 22 (See FIGS. 3 and 4).

FIG. 5B is a cross-sectional view of an intermediate element 20c of the stack, and in particular, of the intermediate element 20c that is immediately above the base element 20a in the stack. The intermediate element 20c is of a similar construction to the base element 20a.

The intermediate element 20c comprises a hollow housing 54 made of an injection-moulded plastics material. The housing 54 defines an internal volume 56 that lies between an upper surface 58 and a base wall 60. When the toy is in its upright state, the base surface 60 of the intermediate element 20c rests on the upper surface 36 of the base element 20a that lies beneath it in the stack (see FIG. 3). As above, the term ‘rests’ means that the intermediate element 20c bears against the upper surface 36 in some way, which may be by virtue of the tautness of the cord pulling the intermediate element 20c against the upper surface 36, and/or it may be by virtue of gravity pulling the intermediate element 20c down against the upper surface 36. In turn, the upper surface 58 of the intermediate element 20c supports another intermediate element that is immediately above it in the stack, such that the upper surface 58 acts as a support surface.

The upper surface 58 is provided with a stop formation 62 that is substantially the same as the stop formation 38 of the base element 20a. The stop formation 62 comprises a head portion 64 and a spacer 66 in the form of a post. The head portion 64 defines a mushroom shape, and has an abutment surface 68 that faces towards the upper surface 58 of the intermediate element 20c to define the stop 30, and a domed surface 70 opposite the abutment surface 68. The post 66 serves to space the head portion 64, and hence the stop 30, away from the upper surface 58 of the intermediate element 20c.

As with the base element 20a described above, where the upper surface 58 of intermediate element 20c meets the post 66, the upper surface 58 is provided with a bevelled region having a sloped surface that lies at an obtuse angle to the upper surface 58. The bevelled region extends all the way round the base of the post to define a collar 72. This collar 72 acts as a locating feature that interacts with a complementary locating feature on the base surface of a neighbouring intermediate element 20c of the stack, as will be described later.

A central bore 75 runs through the stop formation 62 to communicate with the internal volume 56 of the intermediate element 20c. In the assembled toy 10, the cord 28 runs through this central bore 75 into the internal volume 56 (See FIGS. 3 and 4).

The base wall 60 of the intermediate element 20c comprises a circular aperture 74. The aperture 74 has a diameter that is a little larger than the diameter of the post 44 of the stop formation 38 of the base element 20a, but a little smaller than an external dimension of the stop 30 of the stop formation 38. Around the edge of the aperture 74, the base wall 60 is bevelled so as to define a sloped wall 76 that faces downwardly towards the base element 20a when the toy 10 is assembled, and that lies at an obtuse angle to the lower surface of the base wall 60. The sloped wall 76 is shaped so as to co-operate with the collar 48 provided around the post 44 of the base element 20a.

FIG. 5c is a cross-sectional view of the anchoring element 20b. The anchoring element 20b composes a hollow housing 78 made of an injection-moulded plastics material. The housing 78 defines an internal volume 80 that lies between an upper surface 82 and a base wall 84 of the housing. When the toy is in its upright state, the base wall 84 of the anchoring element 20b rests on the upper surface 58 of the intermediate element 20c that lies beneath the anchoring element 20b in the stack. As above, the term ‘rests’ means that the anchoring element 20b bears against the upper surface 58 of the intermediate element 20c in some way, which may be by virtue of the tautness of the cord pulling the anchoring element 20b against the upper surface 58, and/or it may be by virtue of gravity pulling the anchoring element 20b down against the upper surface 58.

The base wall 84 of the anchoring element is substantially the same as the base wall 60 of the intermediate element 20c. The base wall 84 comprises a circular aperture 86, and the aperture 86 has a diameter that is a little larger than the diameter of the post 66 of the stop formation 62 of the intermediate element 20c, but a little smaller than an external dimension of the stop 30 of the stop formation 62. Around the edge of the aperture 86 the base wall 84 is bevelled so as to define a sloped wall 88 that faces downwardly towards the intermediate element 20c when the toy 10 is assembled. The sloped wall 88 is shaped so as to co-operate with the collar 72 provided around the post 66 of the intermediate element 20c.

The upper surface 82 of the anchoring element 20b is provided with an aperture 90 which is sized such that the uppermost section of the cord 28 above the first snap-fit feature 100 can run through the aperture 90 when the toy is assembled.

FIG. 5D shows the base element 20a and the intermediate element 20c arranged in the stack of the assembled toy when in an upright state.

The post 44 of the stop formation 38 of the base element 20a extends through the aperture 74 in the base of the intermediate element 20c. The head portion 40 of the stop formation 38, and hence the abutment surface 42 that serves as the stop 30, is therefore disposed inside the internal volume 56 of the intermediate element 20c.

If the intermediate element 20c and the base element 20a are perfectly aligned, the sloped wall 76 at the edge of the aperture 74 of the intermediate element 20c will lie in contact with the collar 48 around the post 44 of the base element 20a as shown in FIG. 5D. However, if the intermediate element 20c is out of alignment, the sloped wall 76 would not be able to rest directly on the collar 48. In this case, a combination of the returning spring force and gravity will tend to act on the sloping surfaces of the sloped wall 76 to slide the sloped wall over the collar 48 and move the intermediate element 20c into alignment with the base element 20a, thereby allowing complete contact between the sloped wall 76 and the collar 48. In this way, the sloped wall 76 and the collar 48 act as complementary locating features that force the intermediate element 20c into the desired location relative to the base element 20a.

It will be appreciated that the collars 72 the sloped walls 76, 88 of the other intermediate elements 20c and the anchoring element 20b also act as complementary locating features in the same way.

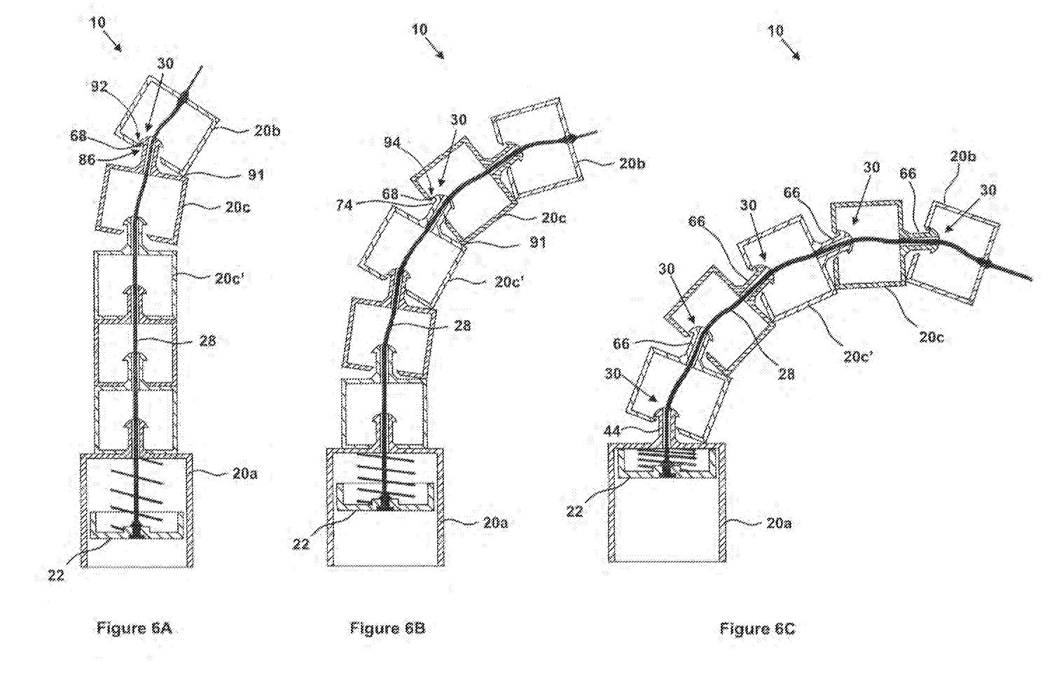

FIGS. 6A to 6C illustrate stages in the topping process of the toy 10.

In this example, the toppling motion can be caused by a combination of two different forces acting on the elements 20a, 20b, 20c of the toy 10.

Firstly, a pushing force is exerted on the anchoring element 20b, by the cord 28. As explained above, the cord 28 has a stiffness along the length of the cord 28. As a result of this stiffness, when the button 22 is pushed, the cord 28 exhibits a resistance against the bending motion that would be induced by the upward movement of the button 22, and pushes against the anchoring element 20b upwardly and outwardly. This pushing force fends to affect the uppermost elements first, causing toppling from the top of the stack.

Secondly, gravitational forces act on the elements. In the stacked configuration the elements have a relatively high gravitational potential energy. If the toy 10 is held at a tilted angle when the button 22 is pressed, the elements will tend to topple under gravity to reduce the gravitational potential energy to that of the fully-toppled state. The toppling action caused by gravity will tend to cause the lowest element of the stack to pivot first, causing toppling from the bottom of the stack.

The toppling effect will be caused by one or both of these forces, depending on how the toy 10 is held during toppling, and on the configuration and/or material of the cord 28. If the toy 10 is held substantially vertically when the button 22 is pressed, the pushing force exerted by the cord 28 will dominate, and the stack will tend to topple from the top. If the toy 10 is held at a steep tilt when the button 22 is pressed, or if the cord 28 is not made of a stiff material such that it cannot exert a pushing force on the elements, the gravitational forces will dominate, and the stack will tend to topple from the bottom. If the toy 10 is held at an intermediate tilt when the button 22 is pressed, both forces will act on the elements to different extents depending on the degree of tilt. In this case, the stack may topple from both the top and the bottom.

FIGS. 6A to 6C illustrate the toppling effect when the toy 10 is held substantially vertically when the button 22 is pressed, such that the pushing force exerted by the cord 28 dominates the toppling process.

Referring to FIG. 6A, when the button 22 is pushed, the pushing action exerted by the cord 28 causes the anchoring element 20b to topple by tipping it about a pivot point 91. Because the aperture 86 of the anchoring element 20b is a little larger than the post 66 of the intermediate element 20c, the anchoring element 20b is free to pivot around the post 66 in any direction. This free movement is also facilitated by the circular cross-section of the post 66 and the aperture 86. This pivoting causes the base surface of the anchoring element 20b to lift away from the upper surface of the intermediate element 20c that lies beneath it in the stack.

The anchoring element 20b continues to tip about the pivot point 91 until the inner surface 92 of the anchoring element 20b in the vicinity of the aperture 86 reaches the stop 30 of the intermediate element 20c. Because the stop 30 is larger than the aperture 86, the stop 30 cannot pass through the aperture 86. The inner surface 92 therefore abuts against the abutment surface 68 of the stop 30, upon which the pivoting movement of the anchoring element 20b is arrested. The anchoring element 20b has moved through its full range of movement relative to the intermediate element 20c, and the anchoring element 20b can move no further.

At this stage the toy 10 is in a partially-toppled state. The total gravitational potential energy of the elements of the stack has been reduced by toppling of the anchoring element 20b, but the total gravitational potential energy of the elements has not yet been reduced to the lowest level permitted, because the elements of the stack have not yet toppled to the maximum extent permitted by the configuration of the toy.

As the button 22 is pushed further, the cord 28 is pushed further upwards, exerting a further force on the anchoring element 20b. Because the anchoring element 20b can move no further relative to the intermediate element 20c, the further pushing force exerted by the cord 28 cannot be accommodated by further tipping of the anchoring element 20b. Instead, the inner surface 92 of the anchoring element 20b exerts a lifting force on the stop 30 of the intermediate element 20c. In this way, the anchoring element 20b effectively pulls the intermediate element 20c over, causing the intermediate element 20c to lift and pivot, as is shown in FIG. 6A.

Referring now to FIG. 6B, the intermediate element 20c pivots in the same manner as the anchoring element 20b described above. The intermediate element 20c continues to tip about the pivot point 91 until an inner surface 94 of the intermediate element 20c reaches the stop 30 of the intermediate element 20c′ that lies below it in the stack. Because the stop 30 is larger than the aperture 74 in the intermediate element 20c, the stop 30 cannot pass through the aperture 74. The inner surface 94 therefore abuts against the abutment surface 68 of the stop 30, and the pivoting movement of the intermediate element 20c is arrested. The intermediate element 20c has moved through its full range of movement relative to the intermediate element 20c′ that lies below it in the stack, and the intermediate element 20c can therefore move no further.

Upon continued pushing of the button 22, the cord 28 is pushed upwards still further exerting a further force on the anchoring element 20b and the intermediate element 20c. This force cannot be accommodated by further movement of the anchoring element 20b or the intermediate element 20c relative to the rest of the stack. Instead, the inner surface 94 of the intermediate element 20c exerts a lifting force on the stop 30 of the intermediate element 20c that lies beneath it in the stack, which causes the intermediate element 20c′ to lift and pivot.

The same pattern of toppling continues moving down the elements towards the base element 20a. Eventually, as shown in FIG. 6C, every element in the stack has moved through its full range of movement, such that the internal surface of every element abuts against the stop 30 of the neighbouring element in the stack. The stack has then toppled to the maximum extent permitted, and is in its fully-toppled state. Because each element has pivoted relative to its neighbouring elements, but has pivoted by only a limited amount, the elements define a curved shape when the stack is in its fully-toppled state.

When the button 22 is released, the cord 28 is tautened again, and the elements 20a, 20b, 20c are pulled back in to the upright configuration of FIG. 3. The complementary locating features 48, 76, 72, 88 (See FIGS. 5A to 5D) act to locate the elements 20a, 20b, 20c relative to one another, such that the stack is perfectly aligned when it is brought into the upright configuration.

By virtue of the stops 30, each and every element of the stack must move through its full range of motion in order to bring the toy into its fully toppled state. A fully-toppled state cannot be achieved by pivoting of the lowest of the intermediate elements alone, as would be the case in conventional pop toys. Thus, the stack cannot topple like a felled tree, but must instead topple by splaying in a controlled manner to define a curved shape. This controlled splaying provides an increased amusement factor compared to conventional pop-toys. It is particularly beneficial when the elements have a relatively large area of contact, for example if the elements have large, flat upper surfaces as in the toy depicted in the accompanying drawings, or if the toy elements are of substantially the same size and shape.

By virtue of the locating features, 48, 76, 72, 88, the elements are perfectly aligned when the toy 10 is returned to the upright state. The toy therefore has a predictable shape and configuration in both the fully-toppled and upright states.

It Will be appreciated that the final shape of the elements in the fully-toppled state is governed by the range of movement that is permitted for each of the different elements. The permitted range of movement is governed in turn by the spacing between the stop 30 and the abutment surface 92, 94 of the neighbouring element in the stack. This spacing is determined by the length of the post 44, 66 that spaces the stop 30 away from the upper surface of the element. A longer post 44, 66 provides a greater spacing and results in a greater range of movement, while a shorter post 44, 66 provides a smaller spacing and results in a smaller range of movement. The final configuration of the elements in the fully-toppled state can therefore be controlled by controlling the length of the post of each element.

In this way, many different shapes could be defined by the elements in the fully-toppled state, depending on the construction of the toy 10. The shape could be selected, for example, such that the shape in the fully-toppled state is appropriate for the object or character that is defined by the elements.

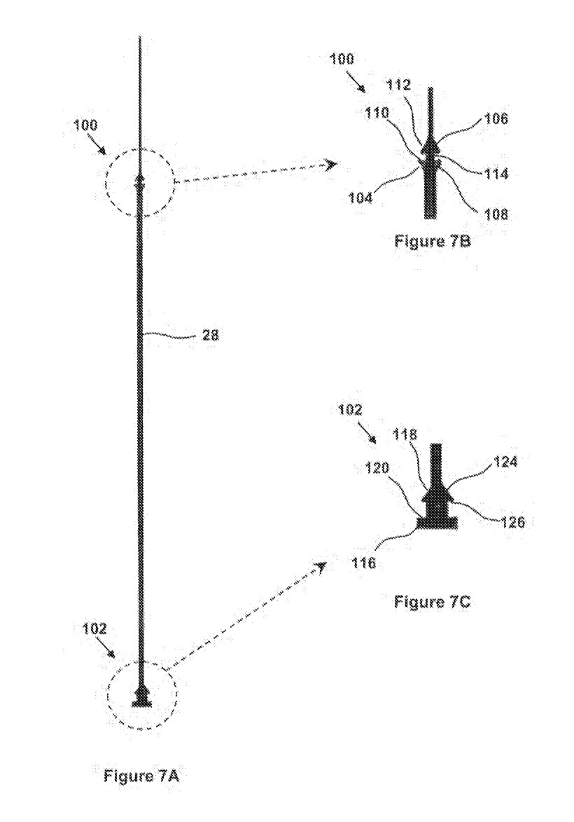

FIGS. 7A to 7C show the cord 28 of the toy 10 in detail. The cord may be used with a pop toy 10 as described above. In which the elements are provided with stops so as to limit relative movement between the elements. However, the cord may be used to equal advantage with pop toys having conventional elements that do not include stops. The stops described above and the cord described below may therefore be used independently of one another if desired.

The cord 28 comprises first and second snap-fit features 100, 102. The first snap-fit feature 100 is provided at an upper end of the cord 28, and, in the assembled toy, engages with the anchoring element 20b (See FIG. 3). The second snap-fit feature 102 is located at a lower end of the cord 28 and in the assembled toy, engages with the button 22 (see FIG. 3).

The first snap-fit feature 100 comprises first and second parts 104, 106.

The first part 104 is lower than the second part 106 and defines a downward facing barb shaped substantially as a cone that is co-axial with the cord 28. The barb comprises a ramped surface 108, and a stop 110. The stop has a diameter that is larger than the aperture 90 in the upper surface of the anchoring element 20b, such that the aperture 90 cannot usually pass over the stop 110.

The second part 106 is higher than the first part 104 and defines an upward-facing barb shaped substantially as a cone that is co-axial with the cord 28. The barb comprises a ramped surface 112, and a stop 114. The stop 114 has a diameter that is slightly larger than the aperture 90 in the upper surface of the anchoring element 20b, so that, normally, the aperture 90 cannot pass over the stop 114. however, the stop 114 is capable of elastic deformation if pressure is applied to the stop 114 in a downward direction via the ramped surface 106. When the stop 114 is elastically deformed, the diameter of the stop is reduced such that the aperture 90 can pass over the stop 114 in a downward or threading direction.

The stops 110, 114 are both smaller than the aperture 122 in the button 22, and the bores 50, 75 in the stop formations 38, 62 of the base element 20a and the intermediate elements 20c (see FIGS. 5A and 5B). In this way, the button, the base element 20a and the intermediate elements 20c can pass over the first engagement feature 100 as they are threaded onto the cord 28.

The second snap-fit feature 102 also comprises first and second parts 116, 118.

The first snap fit part 116 is lower than the second part 118 and defines a disc. An upper surface of the disc acts as a stop 120. The stop 120 has a diameter that is larger than an aperture 122 in the button 22, such that the aperture 122 cannot pass over the stop 120.

The second part 118 is higher than the first part 116 and defines an upward facing barb shaped substantially as a cone that is co-axial with the cord 28. The barb comprises a ramped surface 124, and a stop 126. The stop 126 has a diameter that is slightly larger than the aperture 122 in the button 22, so that, normally, the aperture 122 cannot pass over the stop 126. However, the stop 126 is capable of elastic deformation if pressure is applied to the stop 126 in a downward direction via the ramped surface 124. When the stop 126 is elastically deformed, the diameter of the stop 126 is reduced such that the aperture 122 can pass over the stop 126 in a downward or threading direction.

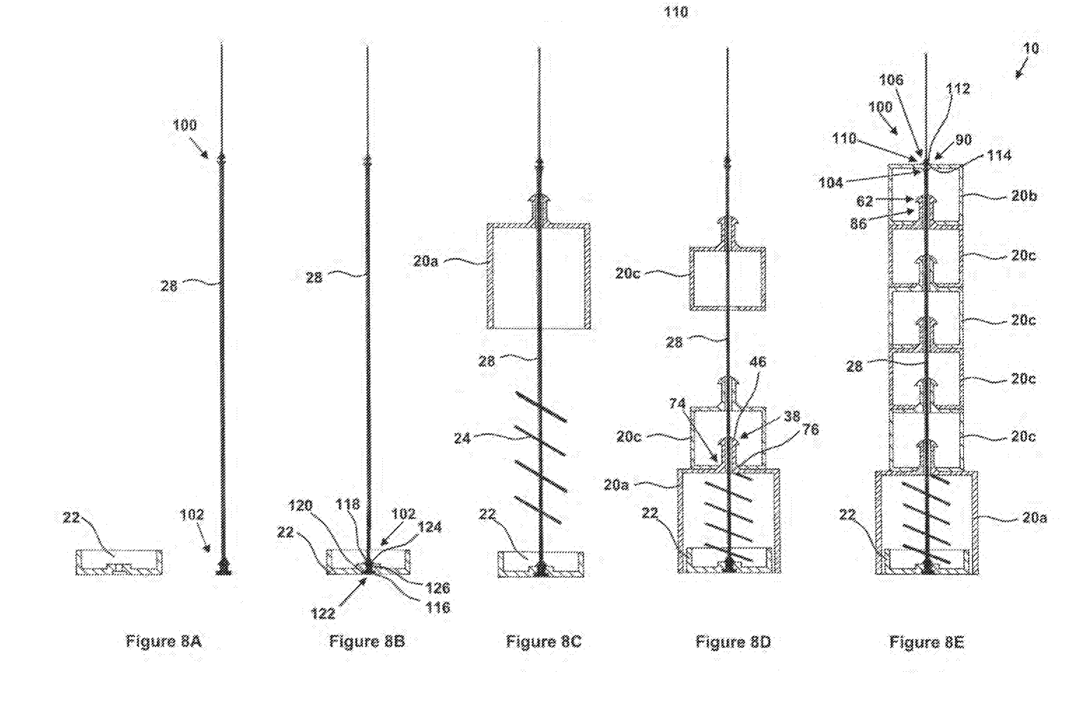

A method of manufacturing a pop toy 10 using the cord 28 of FIGS. 7A to 7C will now be described with reference to FIGS. 8A to 8E.

The venous components of the toy are assembled by threading the components onto the cord 28. The threading action is effected by moving the component relative to the cord in a threading direction. This can be effected, for example, by pulling the cord 28 upwardly whilst holding the component stationary, or by pushing the component downwardly whilst holding the cord 28 stationary, or by a combination of both movements.

First, as shown in FIG. 8A, a cord 28 and button 22 are provided. The button 22 is threaded onto the cord 28 in the threading direction until the aperture 122 of the button 22 reaches the second snap-fit feature 102. The button 22 is pushed onto the ramped surface 124 of the second part 118 such that the stop 126 deforms elastically, allowing the aperture 122 to pass over the stop 126 in the threading direction. This causes the button 22 to snap-fit into engagement with the second snap-fit feature 102 of the cord 28 as shown in FIG. 8B, with the aperture 122 of the button 22 being disposed between the first and second parts 116, 118, and in particular between the stops 120, 126. The stops 120, 126 prevent movement of the button in either the threading or unthreading direction, such that the button is fixed in place relative to the cord.

Other components of the toy 10 are then threaded onto the cord 28 as shown in FIG. 8C. First, the spring 24 is threaded onto the cord until it sits on the button 22. Next, the base element 20a is threaded over the spring 24 and the button 22.

As shown in FIG. 8D, the first intermediate element 20c is then threaded onto the cord 28. The intermediate element 20c is pushed over the stop formation 38 of the base element 20a by pushing the aperture 74 in the base of the intermediate element 20c over stop formation 38. As the aperture 74 is pushed over the stop formation 38, the bevelled edge 76 of the aperture 74 is pushed against the domed surface 46 of the stop formation 38. The pushing action of the opposed sloping walls 76, 46 elastically deforms the base wall of the intermediate element 20c, thereby enlarging the aperture 74 so that the aperture 74 can pass over the stop formation 38.

The threading process continues as further intermediate elements 20c are threaded onto the cord 28 in the same manner.

Turning now to FIG. 8E, once all the intermediate elements 20c have been threaded into place, the anchoring element 20b is threaded onto the cord 28. As the anchoring element 20b is threaded onto the intermediate element 20c that lies below it in the stack, the aperture 86 of the anchoring element 20b passes over the stop formation 62 of the intermediate element 20c in the manner already described above.

Threading the anchoring element 20b onto the cord also pushes the aperture 90 in the upper surface of the anchoring element 20b over the first snap-fit feature 100, thereby snap-fitting the anchoring element 20b into engagement with the cord 28.

To effect the snap fit, the anchoring element 20b is pushed onto the ramped surface 112 of the second snap-fit part 106 such that the stop 114 deforms elastically, allowing the aperture 90 to pass over the stop 114 in the threading direction. This causes the anchoring element 20b to snap-fit into engagement with the first snap-fit feature 100 of the cord 28, with the aperture 90 of the anchoring element 20b being disposed between the first end second parts 104, 106 and in particular between the stops 110, 114. The stops 110, 114 prevent movement of the anchoring element 20b in either the threading or unthreading direction, such that the anchoring element 20b is fixed in place relative to the cord 28.

Once the anchoring element 20b is snap-fitted into place, the cord 28 is anchored between the button 22 and the anchoring element 20b. The cord 28 can then be trimmed above the first snap-fit feature 100. If required a cap (not shown) may be fitted over the anchoring element 20b to hide the first snap-fit feature 100 in the finished toy 10.

The manufacturing method described allows the button 22 and the anchoring element 20b to be snap-fitted onto the cord 28 with a simple threading motion, and there is no need for complicated procedures such as knotting the cord 28. The manufacturing process is therefore simpler than the known process that involved knotting the cord below the button and above the uppermost element of the stack, and more stages of the process can be mechanised, making the process cheaper and more efficient.

Embodiments are envisaged in which the bore hole through the post has a widened mouth at its top and/or bottom end. In these embodiments, the widened mouth acts to guide the cord into the bore hole, even if the cord does not approach the bore hole along exactly the same axis as the bore hole. Thus, as a result of the widened mouth, the element can be more quickly and easily threaded onto the cord.

The toy illustrated in the accompanying drawings is shaped for illustrative purposes as a simple stack of cylinders. However, the toy may take any suitable shape. Any combination of the base element, the anchoring element and the intermediate elements may be shaped so that the toy defines, for example, an object, animal or character.

Although in the illustrated embodiments the toy has four intermediate elements, any number of intermediate elements may be used. For example, the toy may have only one intermediate element.

The stops need not take the form described but may take any suitable form that is capable of allowing the stack of elements to topple while also limiting movement of one element relative to another. For example, the stop need not necessarily be located inside the internal volume of a neighbouring element in the stack and/or located at the centre of the element, but may be arranged in any suitable position that is capable of allowing the stack of elements to topple while also limiting movement of one element relative to another.

Embodiments of the toy are envisaged where the anchoring element is not pivotable relative to the uppermost intermediate element of the stack. For example, the anchoring element may consist of a disc having a small aperture that engages with the first snap-fit feature to anchor the cord to the disc. In this case, the disc may sit on top of the uppermost intermediate element of the stack in contact with the upper surface of the intermediate element in both the upright and fully-toppled states. The disc and the first snap-fit feature may both be hidden by a cap in the finished toy.

It is also envisaged that certain features of the toy may be configured so as to guard against rotation of the elements relative to one another. For example, the button and the internal volume of the base element, may be non-circular in shape, for example, oval or triangular, such that the button cannot rotate within the internal volume. The snap-fit features of the cord and the apertures in the button and anchoring element that receive the snap-fit features may also be non-circular in shape, so that the cord cannot rotate relative to the button or the base element. In this way, the button, base element, cord and anchoring element are fixed in the same orientation and cannot rotate relative to one another. As the toy is toppled and brought back to the upright position, the relative orientation of these components remains fixed, thereby reducing unwanted changes in configuration of the toy.

In the embodiments described, the elements can pivot relative to one another in any direction. The pivoting direction is typically governed by the angle at which the toy is held during toppling. However embodiments are envisaged where the pivoting direction is controlled. For example, the posts of the stop formations and the apertures in the bases of the elements may be shaped so as to limit the pivoting motion to particular direction. For example, the posts and apertures may be of oval cross section, so as to limit pivoting to two directions, or triangular cross-section, so as to limit pivoting to three possible directions.

Although in the embodiments described the cord and movable base are provided as separate elements that are assembled together using a snap-fit arrangement, this need not be the case. The button may, for example, be integrally moulded with the cord, such that the button and cord are provided together as a single component part.

It is also emphasised that the movable base need not take the form of a button but may take any form that is capable of moving so as to tauten and slacken the cord. For example, the cord may be tautened and slackened by winding the cord in the manner of a winch, in which case the movable base may be a rotatable spindle around which the cord is wound. In another example, the cord may be tautened and slackened by simply moving an end of the cord, in which case the movable base may be a portion of the cord that is gripped or otherwise configured for movement.

The invention is therefore not limited to the embodiments described, and the skilled person will appreciate that many variations of the invention are possible within the scope of the appended claims.

1. A toy comprising a stack of elements including at least first, second and third elements having a cord running therethrough, the cord being configurable between a taut state in which the stack is prevented from toppling, and a slack state in which the first, second and third elements are movable relative to one another to effect toppling of the stack, wherein the first element comprises a stop configured to limit movement of the second element relative to the first element to a pre-determined range such that the stack is only partially toppled by movement of the second element through the pre-determined range, and movement of the first and/or third element is necessary for the stack to reach a fully-toppled state.

2. The toy of claim 1, wherein the second element defines an internal volume, and the stop of the first element is located inside the internal volume of the second element.

3. The toy of claim 1, wherein the first element comprises a support surface and the second element rests on the support surface when the first and second elements are arranged in the stack.

4. The toy of claim 3, wherein the stop is spaced apart from the support surface by a spacer.

5. The toy of claim 4, wherein the cord runs through the spacer.

6. The toy of claim 4, wherein the spacer is a post.

7. The toy of claim 5, wherein the second element has a base wall comprising an aperture and the spacer extends through the aperture into the internal volume of the second element.

8. The toy of claim 7, wherein at least one dimension of the aperture is smaller than a dimension of the stop so as to guard against the stop passing through the aperture to limit movement of the second element relative to the first element, and/or at least one dimension of the aperture is larger than a dimension of the spacer to allow the second element to pivot relative to the first element.

9. (canceled)

10. The toy of claim 3, wherein the stop is provided on a stop formation, the stop formation preferably comprising an abutment surface that faces towards the support surface of the first element, and a sloped surface opposite the abutment surface.

11.-14. (canceled)

15. The toy of claim 1, wherein the second element comprises an abutment surface for abutting against the stop to restrict movement of the second element relative to the first element.

16. The toy of claim 15, wherein the abutment surface is an internal wall of the second element.

17. The toy of claim 1, wherein the first and second elements comprise complementary locating features configured to align the second element relative to the first element when the first and second elements are arranged in the stack.

18. (canceled)

19. The toy of claim 17, wherein the locating feature of the first element comprises a projection on the support surface.

20. The toy of claim 19, wherein the projection defines a bevel that extends at least partially around the base of the spacer, and wherein the bevel comprises at least one sloping wall that lies at an obtuse angle to the support surface.

21.-22. (canceled)

23. The toy of claim 19, wherein the locating feature of the second element comprises a recess on the base surface.

24. The toy of claim 23, wherein the recess comprises at least one sloping wall that lies at an obtuse angle to the base surface, and wherein the recess is defined by a beveled wall that surrounds the aperture of the second element.

25. (canceled)

26. The toy claim 1, wherein the second element comprises a stop configured to limit movement of the third element relative to the second element to a pre-determined range.

27. (canceled)

28. The toy of claim 1, wherein one of the elements is a base element that houses a button configured to slacken the cord when the button is pressed.

29.-31. (canceled)

32. The toy of claim 1, wherein the first element comprises a first abutment surface that defines the stop and the second element comprises a second abutment surface that is configured to abut against the stop to restrict movement of the second element relative to the first element.

33. The toy of claim 32, wherein the first and second abutment surfaces are arranged to face each other when the cord is in the taut state, and wherein the first and second abutment surfaces are spaced apart from one another when the cord is in the taut state and are configured to move towards one another as the stack topples.

34.-68. (canceled)

69. The toy of claim 1, wherein the toy is shaped substantially as genitalia.

70.-71. (canceled)
